(19) United States
(12) Patent Application Publication
(10) Pub. No.: US 2004/0087340 A1
(43) Pub. Date: May 6, 2004

(54) Method, and telecommunications apparatus, for providing measurement reporting criteria to a mobile user terminal

(76) Inventors: Qiang Cao, Swindon (GB); Patrick Georges Venceslas Charriere, Tetbury (GB); Seau Sian Lim, Swindon (GB); Philip Charles Sapiano, Corsham (GB)

Correspondence Address: Docket Administrator (Room 3J-219), Lucent Technologies, Inc., 101 Crawfords Corner Road, Holmdel, NJ, 07733-3030, US

(21) Appl. No.: 10/640,109

(22) Filed: Aug. 13, 2003

(30) Foreign Application Priority Data
Nov. 5, 2002 (EP) 02257634.2

(51) Int. Cl. H04M 1/00; H04B 1/38; H04Q 7/20

(52) U.S. Cl. 455/560; 455/423; 455/424

(57) ABSTRACT

A method is provided of providing to a mobile user terminal a set of measurement reporting criteria to be applied by the mobile user terminal in respect of a predetermined cell of a radio telecommunications network. The network comprises a plurality of cells and a controller. The method comprises the controller selecting the set of criteria from stored sets of criteria, one set of which is a default set for all cells under the control of the controller, and another set of which is a cell-specific set of criteria.

### CROSS REFERENCE TO RELATED APPLICATION

This application claims priority of European Application No. 02257634.2 filed on Nov. 5, 2002.

### TECHNICAL FIELD

The present invention relates to mobile communications.

### BACKGROUND OF THE INVENTION

In a code division multiple access (CDMA) system for mobile telecommunications such as a Universal Mobile Telecommunications System (UMTS), a mobile user terminal may be in a region in which soft-handover (also known as soft-handoff) is possible. In a soft-handover scenario, the signal from a mobile user terminal can be received by more than one cell of a network.

For soft-handover to work, one important aspect is to have measurement reporting by the mobile user terminal (sometimes referred to as user equipment, UE) of e.g. the strength of signals received from cells above a predetermined threshold. The measurement reporting from the mobile user terminal is controlled by the UMTS terrestrial radio access network (UTRAN) by way of sending reporting criteria to the mobile user terminal. Each base station has different reporting criteria (i.e. reporting criteria may differ on a per cell basis). It is necessary that the correct reporting criteria be used to give up-to-date measurement reporting. The reporting criteria normally consists of event-triggered conditions.

For inter-frequency handover (i.e. from one set of frequency bands to another) and inter-radio access technology handover (i.e. from one radio access technology to another, often referred to as inter-RAT handover, e.g. from a UTRAN network to a General Packet Radio Service (GPRS) network), measurement reporting criteria are also needed by the mobile user terminal in order to make a measurement report to the UTRAN network.

The known approach is that the serving radio network controller (RNC) controlling communications with the mobile user terminal has to know the reporting criteria of every cell it controls as well as neighboring cells controlled by the drift radio network controller. In object oriented design of a radio network controller (RNC), the reporting criteria is stored in each cell server within the radio network controller (RNC).

There are several problems with the known approach as follows. Firstly, any change in the reporting criteria in a cell as a result of a change in a neighboring cell associated with another radio network controller (the drift radio network controller) requires communication from the drift radio network controller to the serving radio network controller via an operations and maintenance center (OMC-U). This is a tedious manual update procedure, and is prone to human error. The task is even more complicated if the serving radio network controller and drift radio network controller are under the control of different vendors. There is no standard interoperability when a serving radio network controller is controlled by an operations and maintenance center of one vendor and another by an operations and maintenance center of another vendor.

Secondly, it is likely that the reporting criteria are the same for most cells in a network. The reporting criteria only needs to be customized for each cell in certain relative small areas (e.g. densely urban areas).

Thirdly, as shown in FIG. 1 the reporting criteria of different cells controlled by a radio network controller (RNC) are stored in different servers, (server #1 (denoted 11 in FIG. 1 stores the data for cell number 1 to cell number I, and server #2 stores the data for cell number i+1 to cell number j) within the radio network controller. In order to retrieve the reporting criteria for a cell, an internal query mechanism needs to be set up and the information is obtained (by a system controller 15), using this mechanism, from one of the servers or another 11,13. In the worst case scenario, there will thus be a lot of internal traffic if the reporting criteria are stored in different servers and this will thus reduce the radio network controller performance.

Fourthly, using an object-orientated query mechanism within the radio network controller (RNC), as shown in FIG. 2 each call for reporting criteria of a cell requires a system object 17 to query the appropriate cell object 19 which itself queries an associated set of reporting criteria 21 for that cell. Accordingly, a large amount of memory is required in the radio network controller to store the reporting criteria information for each cell.

### SUMMARY OF THE INVENTION

An embodiment of the present invention provides a method of providing to a mobile user terminal a set of measurement reporting criteria to be applied by the mobile user terminal in respect of a predetermined cell of a radio telecommunications network, the network comprising a plurality of cells and a controller, the method comprising the controller selecting the set of criteria from stored sets of criteria, one set of which is a default set for cells under the control of the controller, and another set of which is a cell-specific set of criteria.

In an embodiment of the invention the network is a Universal Mobile Telecommunications System (UMTS) network, the controller being a Radio Network Controller (RNC) controlling a plurality of base stations each of which has at least one associated cell.

In an embodiment, reporting criteria are obtained by, within the controller, a system object being directed to a cell object, each cell object having a pointer to the stored set of reporting criteria for that cell, at least two cell objects pointing to the same set of reporting criteria. Alternatively, reporting criteria are obtained by, within the controller, a system object being directed to the default set of reporting criteria upon determination that the cell object for the cell has no pointer to another stored set of reporting criteria.

The stored sets of criteria further comprise a set of criteria applicable to a subset of the cells controlled by the controller, the subset comprising at least two cells.

In an embodiment, the network comprises a further controller controlling further cells, the further controller being operative to provide to the controller the set of reporting criteria applicable to one of the further cells in response to a request from the controller. Preferably the request is a call set up request.

In an embodiment for a cell controlled by the serving radio network controller, the measurement reporting criteria information may be on cell level (i.e. different for different cells) or at a higher applicable to some or all the cells controlled by a radio network controller. Two level or multi-level measurement reporting criteria are thus provided. The number of reporting criteria objects, and hence the amount of queries between objects, required in the radio network controller is reduced. In consequence, the performance of the radio network controller is enhanced.

Embodiments of the present invention have several advantages. A need to perform manual input by the operator of measurement reporting criteria for each cell is overcome. The number of objects required to store the measurement reporting criteria is reduced. The amount of inter-server traffic within a radio network controller in looking up reporting criteria for cells is reduced and thus radio network controller performance is improved. Furthermore, the amount of duplicated information in a database in the radio network controller is reduced.

Improvements are thus provided in the provision of measurement reporting criteria at a radio network controller for use by a mobile user terminal for soft-, inter-frequency, or inter-radio access technology handovers. Radio network controller performance is increased in dealing with soft-handover, inter-frequency handover and inter-radio access technology handover situations.

In some embodiments, a cell controlled by a radio network controller other than the serving radio network controller will provide the measurement reporting criteria information when a radio connection is established to the cell in the soft-handover case. Communication is provided of the measurement reporting criteria from neighboring radio network controller (RNC) while setting up radio connections. This will ensure that the serving radio network controller does not have to contain all the measurement reporting criteria information of cells belonging to other radio network controllers (RNC) obtained via the operations and maintenance center (OMC-U). There is thus improved inter-operability between radio network controllers (RNCs) from different vendors. Use of explicit signalling is possible for the serving radio network controller to request measurement reporting criteria from the radio network controller which controls the cell or contains the cell information, particularly in the case of inter-RAT and inter-frequency handovers.

An embodiment of the present invention also provides a radio telecommunications network comprising a plurality of cells and a controller, and operative to provide to a mobile user terminal in respect of a predetermined cell a set of measurement reporting criteria to be applied for that cell, the controller comprising storage means operative to store sets of criteria, one set of which is a default set for cells under the control of the controller, and another set of which is a cell-specific set of criteria, and selection means operative to select the set of criteria applicable to the cell.

An embodiment of the present invention also provides a radio telecommunications controller operative to provide for a mobile user terminal in respect of a predetermined cell of a telecommunications network a set of measurement reporting criteria to be applied for that cell, the controller comprising storage means operative to store sets of criteria, one set of which is a default set for all under the control of the controller, and another set of which is a cell-specific set of criteria, and selection means operative to select the set of criteria applicable to the cell.

### BRIEF DESCRIPTION OF THE DRAWING

An embodiment of the present invention will now be described by way of example and with reference to the drawings, in which:

FIG. 1 is a diagram illustrating how reporting criteria of a cell are obtained by its controlling radio network controller (prior art),

FIG. 2 is a diagram illustrating objects used by a radio network controller in determining reporting criteria of cells that it controls (prior art),

FIG. 3 is a diagram illustrating a Universal Mobile Telecommunications System (UMTS) terrestrial radio access network (UTRAN),

FIG. 4 is a diagram illustrating regions of coverage by the network,

FIG. 5 is a diagram illustrating some objects used by a radio network controller in determining reporting criteria of cells that it controls,

FIG. 6 is a diagram illustrating one option for configuring the objects shown in FIG. 5 so as to determine the reporting criteria of the cells,

FIG. 7 is a diagram illustrating another option for configuring the objects shown in FIG. 5 so as to determine the reporting criteria of the cells,

FIG. 8 is a diagram illustrating how reporting criteria usable in respect by one or some cells can be obtained, and

FIG. 9 is a diagram illustrating how reporting criteria are obtained for a cell under the control of another radio network controller.

### DETAILED DESCRIPTION

In the described embodiment, the network is a code division multiple access (CDMA) system for mobile telecommunications, in particular a Universal Mobile Telecommunications System (UMTS) terrestrial access network (UTRAN). When a mobile user terminal is in a region in which soft-handover is possible, the signal from a mobile user terminal can be received by more than one cell of the network. Combining the signals from different cells provides soft-handover gain (i.e. the benefit of being able to select the strongest signal in the uplink (i.e. in the direction from a mobile to the base station).

For soft-handover to work, one important aspect is to have measurement reporting from the mobile user terminal (sometimes referred to as user equipment, UE). The measurement reporting from the mobile user terminal is controlled by the network by way of sending reporting criteria to the mobile user terminal. Reporting criteria of a cell are obtained by its controlling radio network controller for transmission to and use by a mobile user terminal. Different reporting criteria can be applied in each cell (i.e. reporting criteria may differ on a per cell basis). It is necessary that the correct reporting criteria are used to give up-to-date measurement reporting. The reporting criteria normally consists of event-triggered conditions. (Examples of event-triggered condition can be found in for example Third Generation Partnership Project (3GPP) Technical Specification 25.331 Section 14.1.2). The reporting criteria includes, for example, whether the signal strength from the cell is above a first threshold whereby the cell is to be included in the active set of cells having a radio connection to a mobile user terminal; or is below a second threshold whereby the cell is removed from the active set by taking down the radio connection. Another measurement criterion depends on hysteresis (i.e. the time for which the criteria must be met before that is reported).

For inter-frequency handover (i.e. from one set of frequency bands to another) and inter-radio access technology handover (i.e. from one radio access technology to another, e.g. from a UTRAN network to a General Packet Radio Service (GPRS)network), measurement reporting criteria are also needed by the mobile user terminal in order to make a measurement report to the UTRAN network.

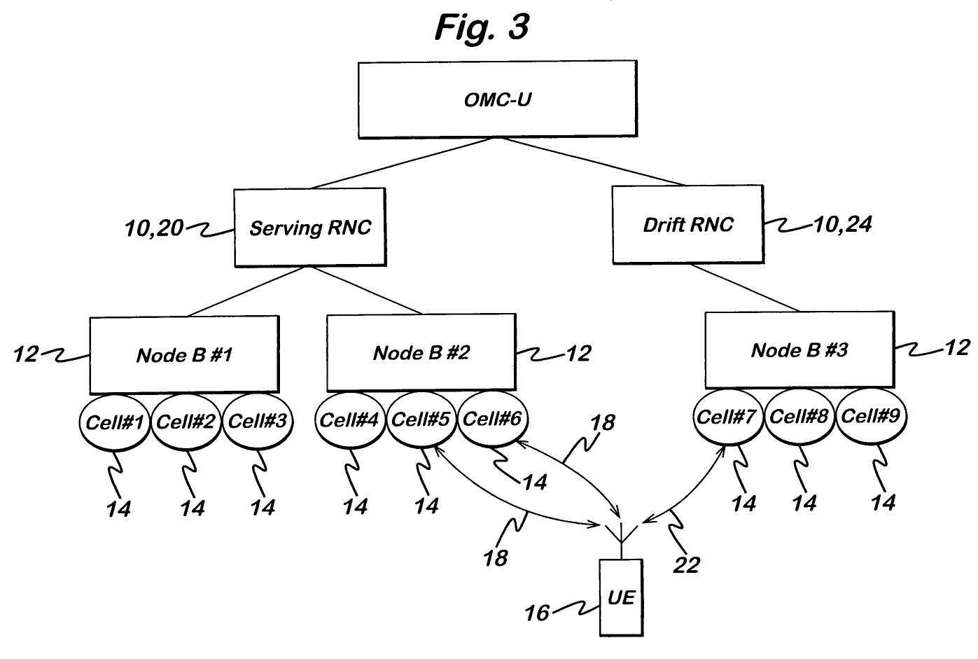

The architecture of the UTRAN network is basically, as shown in FIG. 3. In the Figure only two radio network controllers 10, three base stations 12, nine cells 14 and one mobile user terminal 16 are shown for simplicity. Each base station 12 (Node B in UMTS terminology) of the network typically has three radio coverage areas (i.e. cells, also known as sectors) as the base station has three directional antennas angled at 120 degrees to each other. Radio network controllers (RNC) each control several base stations and hence a number of cells.

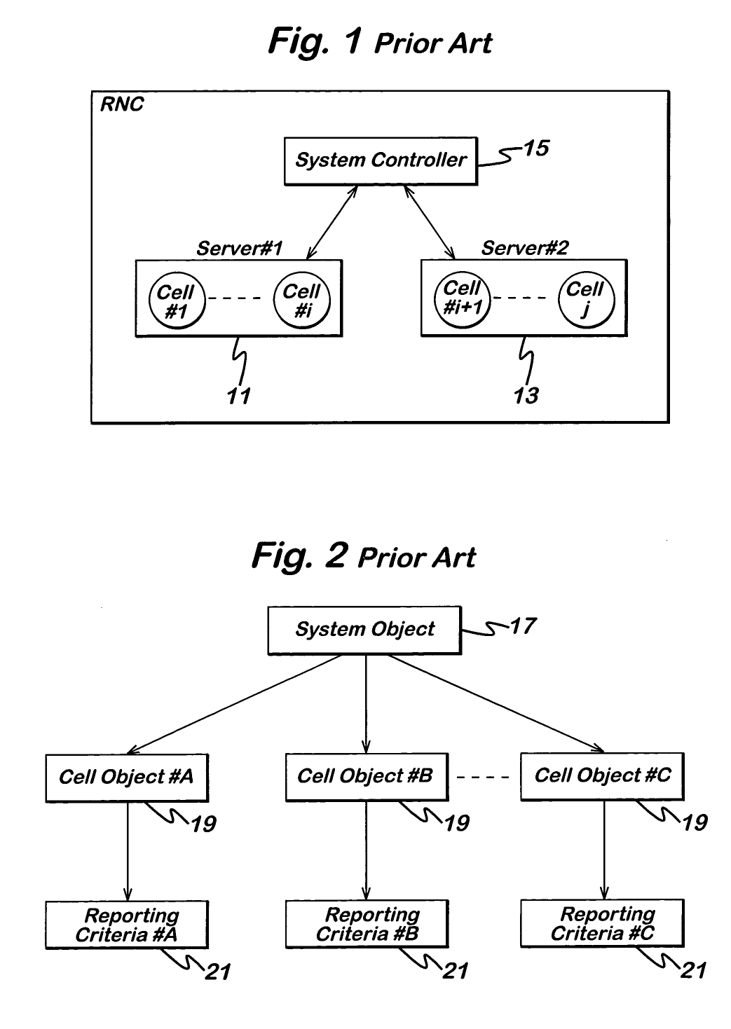

FIG. 3 shows three radio connections in a soft-handover scenario. Two of the radio connections 18 are to cells (cell 5 and cell 6 in FIG. 3) controlled via a base station (Node B) by a serving radio network controller (SRNC) 20 and the other radio connection 22 is to a cell (cell 7) controlled (via another base station) by another radio network controller, known as a drift radio network controller (DRNC) 24. The mobile user terminal 16 is provided with the reporting criteria for one of Cell 5, 6 or 7 shown in FIG. 1 dependent on which of those cells gives the strongest signal.

As shown in FIG. 3, each radio network controller (RNC) 10, regardless of whether a serving radio network controller (SRNC) 20 or drift radio network controller (DRNC) 24, controls an associated set of cells 14 via base stations 12. Each radio network controller (RNC) 10 stores information, including the reporting criteria of the cells 14 that it controls. Within a radio network controller (RNC) 10 it is not necessary to store reporting criteria and possible other information of each cell as those criteria are likely to be the same.

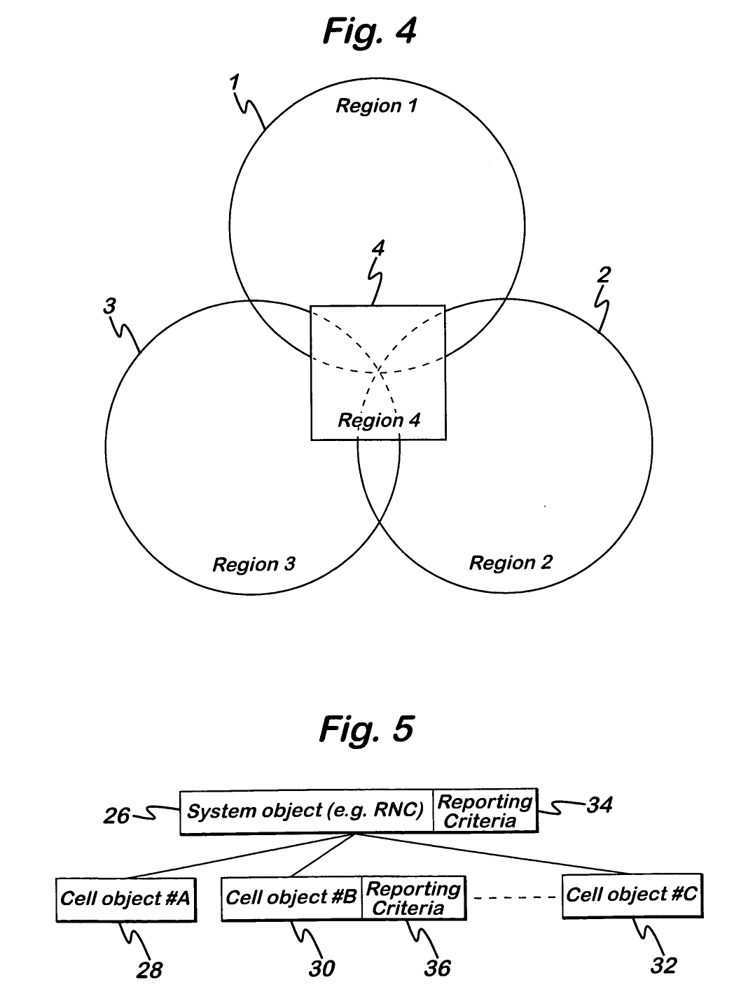

Turning now to FIG. 4, each of geographical regions 1,2,3, and 4 contain a set of cells (not shown in the Figure) controlled by a respective single radio network controller (not shown in the Figure). For region 1, as the radio propagation environment is uniform across that region, the cells within that region have the same (i.e. common) reporting criteria. Similarly for region 2, as the channel environment is uniform across that region, the cells within that region have the same reporting criteria. Similarly for region 3, as the radio propagation environment is uniform across that region, the cells within that region have the same reporting criteria. However for region 4, the radio propagation environment varies (due to the terrain being mountainous for example. Thus each of the cells within region 4 requires different reporting criteria.

Hierarchical Measurement Reporting Criteria

As generally most of the cells have the same measurement reporting criteria, it is wise to have the measurement reporting criteria on two-levels: one being on cell level (i.e. different for different cells) and the other being at a higher level. The higher level criteria can apply to a subset of the cells controlled by a radio network controller (RNC), all of the cells controlled by a radio network controller (RNC), or even the cells controlled by more than one radio network controller (RNC). The lower level (i.e. the cell level) is more tailored for a particular cell so when cell-specific measurement criteria exist, these take precedence. An illustration is provided in FIG. 5.

FIG. 5 illustrates an object-orientated query mechanism which occurs within the radio network controller (RNC) to determine the reporting criteria for a cell controlled by the radio network controller. The system object 26 requesting the information makes a reference to (in other words has a pointer to) another object, namely a cell object for the cell under consideration (be that cell object A 28, cell object B 30, or cell object C 32. As is well known in the field of object-orientated design, an object is a database plus some computational intelligence with which to process data. In FIG. 5, cell object A and cell object C use the reporting criteria 34 which are kept as default in the system object 26 while cell object B uses its own cell-specific reporting criteria 36 which is part of cell object B.

The basic approach shown in FIG. 5 can be implemented in different ways as described immediately below.

First Option

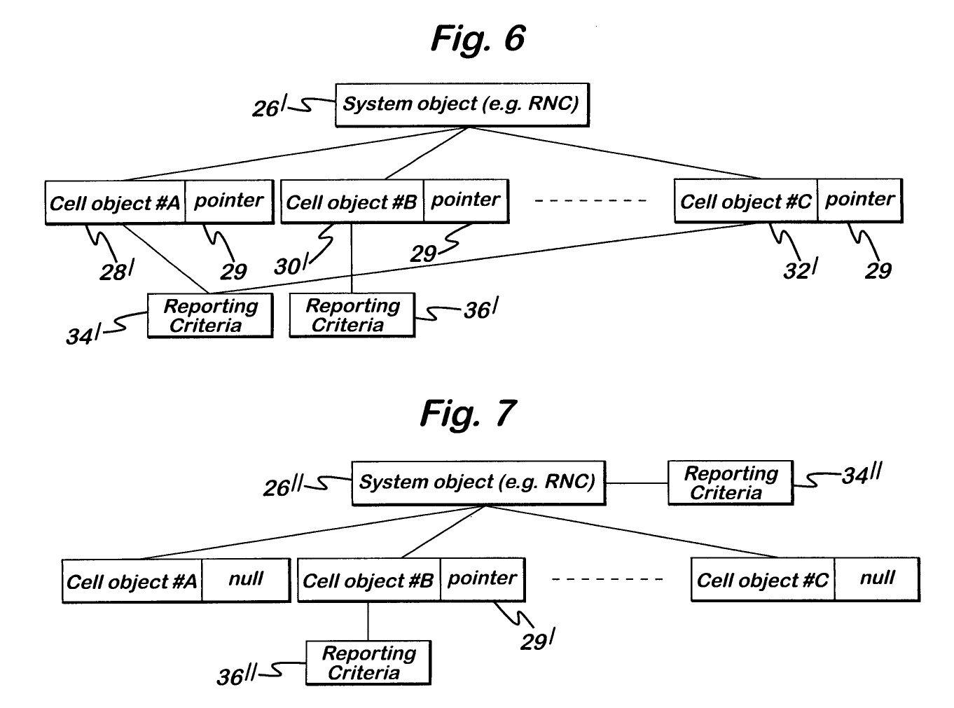

As shown in FIG. 6, within a radio network controller (RNC), the set of reporting criteria is obtained for the system object using pointers 29 from cell objects. When reporting criteria 34′ for cell object A or cell object C is required by the system object 26′, the system object 26′ asks cell object A (28′) or cell object C (32′) for the reporting criteria 34′to be applied. Hence the number of objects for reporting criteria is small but the large number of queries from the system object remains.

(Incidentally as shown in the FIG. 6, when reporting criteria 36′ for cell object B is required, the system object 26′ asks cell object B (30′) for the reporting criteria 34′ to be applied. Cell object B (30′) has a pointer to the reporting criteria 36′)

Second Option

As shown in FIG. 7, reporting criteria for the system object 26″ is obtained using a pointer from the system object itself directly to the reporting criteria 34′ for cell A or cell C. Incidentally as shown in the FIG. 7, when reporting criteria 36″ for cell object B is required, the system object 26″ asks cell object B (30″) for the reporting criteria 34″ to be applied. Cell object B (30″) has a pointer 29′ to the reporting criteria 36″

This second option reduces both the number of objects as well as the number of inter-object queries whereas the first option only reduces the number of objects (compared to the prior art approach illustrated in FIG. 2 in which each cell has its associated reporting criteria stored in the radio network controller).

Extension to other Levels

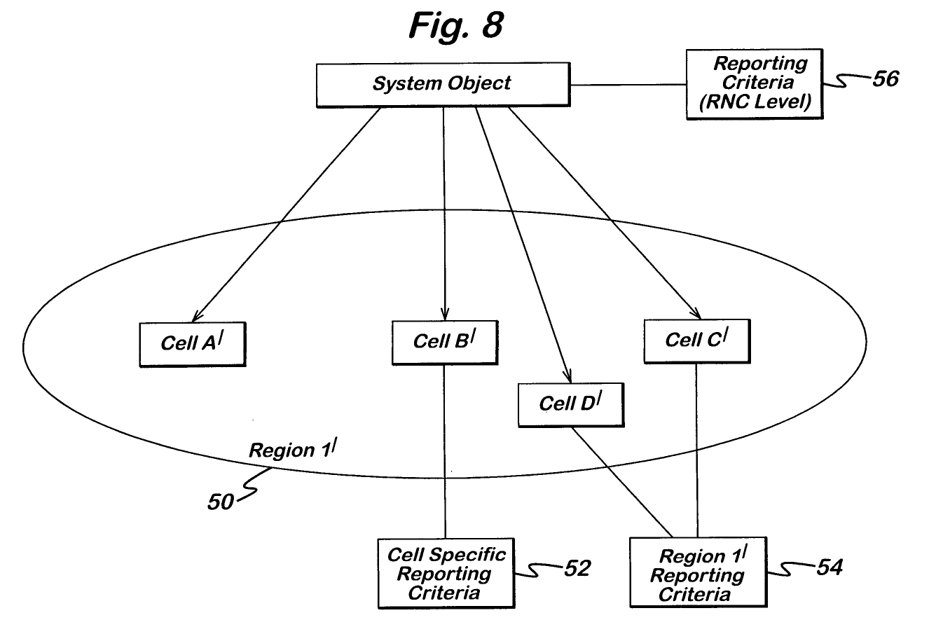

This approach can be extended to multiple levels as shown in FIG. 8. As shown in FIG. 8, the cells in region 1′ can use cell specific reporting criteria, reporting criteria applicable across region 1′ only, or a standard reporting criteria for cells controlled by the radio network controller. For example with reference to FIG. 8, uses radio network controller (RNC) level reporting criteria, cell B′ uses cell specific reporting criteria, and cells C′ and D′ use region 1′ specific reporting criteria.

Sending Measurement Reporting Criteria as Part of Radio Connection Establishment

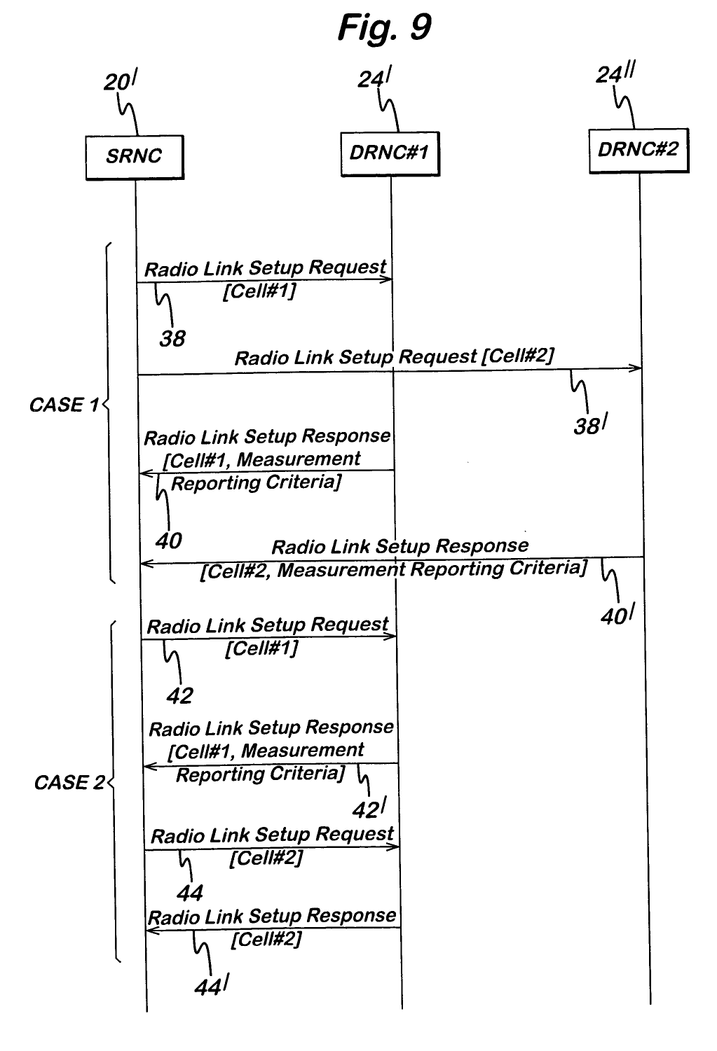

The measurement reporting criteria from cells connected to a drift radio network controller are sent whenever a radio connection is established. FIG. 9 shows in example case 1 the normal scenario of setting up radio connections including sending radio connection set up requests 38, 38′ to the two drift radio network controllers 24′, 24″ (also denoted DRNC1, DRNC2 in FIG. 9) and the responses 40,40′ from the two drift radio network controllers 24′,24″, those responses containing the measurement reporting criteria for the cells (denoted cell #1, cell #2 in FIG. 9) connected to the drift radio network controllers. If no measurement reporting criteria is in the response message 40,40′, the serving radio network controller (SRNC) 20′ uses its own default measurement reporting criteria rather than cell-specific measurement criteria.

Example case 2 in FIG. 9 shows the case when a radio connection between a mobile user terminal and a neighboring cell is already established (using radio connection set up request 42 and response 42′) under the control of the drift radio network controller (24′, DRNC1 in FIG. 9) and later, a second radio connection with the mobile user terminal is requested 44 to be set up under the control of the same drift radio network controller (24′, DRNC1) and with the same measurement reporting criteria as the first radio connection. In this case, the second radio link setup response 44′ from the drift radio network controller (24′, DRNC1) does not include the measurement reporting criteria.

Explicit Message Requesting Reporting Criteria

In an alternative embodiment, rather than getting the measurement reporting criteria in reply to a radio link setup request, (i.e. instead of having the drift radio network controller respond with reporting criteria whenever a radio connection in being set up under the control of the drift radio network controller), the serving RNC requests the measurement reporting criteria from the drift radio network controller (DRNC) using an explicit message whenever it needs to.

For example, serving radio network controller can request the measurement reporting criteria for the strongest cell. In other words, the serving radio network controller requests the reporting criteria from the drift radio network controller only if the cell (to which the radio connection is to be set up) is the cell with least signal attenuation to and from the mobile user terminal (i.e. strongest cell) within the set of cells (the “active set”)in radio connection with the mobile user terminal.

This mechanism is particular suitable for inter-radio access technology and inter-frequency handovers.

1. A method of providing to a mobile user terminal a set of measurement reporting criteria to be applied by the mobile user terminal in respect of a predetermined cell of a radio telecommunications network, the network comprising a plurality of cells and a controller, the method comprising the controller selecting the set of criteria from at least two stored sets of criteria, one set of which is a default set for cells under the control of the controller, and another set of which is a cell-specific set of criteria.

2. The method according to claim 1, wherein the network is a Universal Mobile Telecommunications System (UMTS) network, and the controller is a Radio Network Controller (RNC) controlling a plurality of base stations each of which has at least one associated cell.

3. The method according to claim 1, wherein reporting criteria are obtained by, within the controller, a system object being directed to a cell object, each cell object having a pointer to the stored set of reporting criteria for that cell, at least two cell objects pointing to the same set of reporting criteria.

4. The method according to claim 1, wherein reporting criteria are obtained by, within the controller, a system object being directed to the default set of reporting criteria upon determination that the cell object for the cell has no pointer to another stored set of reporting criteria.

5. The method according to claim 1, wherein the stored sets of criteria further comprise a set of criteria applicable to a subset of the cells controlled by the controller, the subset comprising at least two cells.

6. The method according to claim 1, wherein the network comprises a further controller controlling further cells, the further controller being operative to provide to the controller the set of reporting criteria applicable to one of the further cells in response to a request from the controller.

7. The method according to claim 6, wherein the request is a call set up request.

8. A radio telecommunications network comprising a plurality of cells and a controller operative to communicate with a mobile user terminal, the network being operative to provide to the mobile user terminal in respect of a predetermined cell a set of measurement reporting criteria to be applied for that cell, the controller comprising storage means operative to store at least two sets of criteria, one set of which is a default set for cells under the control of the controller, and another set of which is a cell-specific set of criteria, and selection means operative to select the set of criteria applicable to the cell.

9. A radio telecommunications controller operative to provide for a mobile user terminal in respect of a predetermined cell of a telecommunications network a set of measurement reporting criteria to be applied for that cell, the controller comprising storage means operative to store sets of criteria, one set of which is a default set for cells under the control of the controller, and another set of which is a cell-specific set of criteria, and selection means operative to select the set of criteria applicable to the cell.
